(19) United States
(12) Patent Application Publication
(10) Pub. No.: US 2008/0218912 A1
(43) Pub. Date: Sep. 11, 2008

(54) CPP-type magnetoresistive element having spacer layer that includes semiconductor layer

(75) Inventors: Kei Hirata, Tokyo (JP); Satoshi Miura, Tokyo (JP); Takeo Kagami, Tokyo (JP); Tetsuro Sasaki, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 11/715,984

(22) Filed: Mar. 9, 2007

(51) Int. Cl. G11B 5/39

(52) U.S. Cl. 360/324

(57) ABSTRACT

An MR element includes: a free layer whose direction of magnetization changes in response to a signal magnetic field; a pinned layer whose direction of magnetization is fixed; and a spacer layer disposed between these layers. The spacer layer includes: a semiconductor layer made of an n-type semiconductor; and a Schottky barrier forming layer made of a metal material having a work function higher than that of the n-type semiconductor that the semiconductor layer is made of, the Schottky barrier forming layer being disposed in at least one of a position between the semiconductor layer and the free layer and a position between the semiconductor layer and the pinned layer, touching the semiconductor layer and forming a Schottky barrier at an interface between the semiconductor layer and itself The semiconductor layer is 1.1 to 1.7 nm in thickness, and the Schottky barrier forming layer is 0.1 to 0.3 nm in thickness.

### BACKGROUND OF THE INVENTION

1. Field of the Invention

The present invention relates to a magnetoresistive element, and to a thin-film magnetic head, a head gimbal assembly, a head arm assembly and a magnetic disk drive each of which includes the magnetoresistive element, and relates to a magnetic memory element.

2. Description of the Related Art

Performance improvements in thin-film magnetic heads have been sought as areal recording density of magnetic disk drives has increased. A widely used type of thin-film magnetic head is a composite thin-film magnetic head that has a structure in which a write head having an induction-type electromagnetic transducer for writing and a read head having a magnetoresistive element (that may be hereinafter referred to as MR element) for reading are stacked on a substrate.

MR elements include GMR (giant magnetoresistive) elements utilizing a giant magnetoresistive effect, and TMR (tunneling magnetoresistive) elements utilizing a tunneling magnetoresistive effect.

Read heads are required to have characteristics of high sensitivity and high output power. As the read heads that satisfy such requirements, GMR heads that employ spin-valve GMR elements have been mass-produced. Recently, to accommodate further improvements in areal recording density, developments have been pursued for read heads employing TMR elements.

A spin-valve GMR element typically includes a free layer, a pinned layer, a nonmagnetic conductive layer disposed between the free layer and the pinned layer, and an antiferromagnetic layer disposed on a side of the pinned layer farther from the nonmagnetic conductive layer. The free layer is a ferromagnetic layer whose direction of magnetization changes in response to a signal magnetic field. The pinned layer is a ferromagnetic layer whose direction of magnetization is fixed. The antiferromagnetic layer is a layer that fixes the direction of magnetization of the pinned layer by means of exchange coupling with the pinned layer.

Conventional GMR heads have a structure in which a current used for detecting magnetic signals (that is hereinafter referred to as a sense current) is fed in the direction parallel to the plane of each layer making up the GMR element. Such a structure is called a CIP (current-in-plane) structure. On the other hand, developments have been pursued for another type of GMR heads having a structure in which the sense current is fed in a direction intersecting the plane of each layer making up the GMR element, such as the direction perpendicular to the plane of each layer making up the GMR element. Such a structure is called a CPP (current-perpendicular-to-plane) structure. A GMR element used for read heads having the CPP structure is hereinafter called a CPP-GMR element. A GMR element used for read heads having the CIP structure is hereinafter called a CIP-GMR element.

Read heads that employ TMR elements mentioned above have the CPP structure, too. A TMR element typically includes a free layer, a pinned layer, a tunnel barrier layer disposed between the free layer and the pinned layer, and an antiferromagnetic layer disposed on a side of the pinned layer farther from the tunnel barrier layer. The tunnel barrier layer is a nonmagnetic layer through which electrons are capable of passing with spins thereof conserved by the tunnel effect. Typically, the tunnel barrier layer is an insulating layer formed of an insulating material such as aluminum oxide or magnesium oxide. The free layer, the pinned layer and the antiferromagnetic layer of the TMR element are the same as those of the spin-valve GMR element. As compared with the spin-valve GMR element, the TMR element is expected to provide a higher magnetoresistance change ratio (hereinafter referred to as an MR ratio), which is the ratio of magnetoresistance change with respect to the resistance.

JP 2003-298143A discloses an MR element of the CPP structure including a magnetization pinned layer whose direction of magnetization is pinned, a magnetization free layer whose direction of magnetization changes in response to an external magnetic field, and an intermediate layer located between the magnetization pinned layer and the magnetization free layer, wherein the intermediate layer includes a first layer (an oxide intermediate layer) made of an oxide and having a region in which the resistance thereof is relatively high and a region in which the resistance thereof is relatively low, and wherein, when a sense current passes through the first layer, the sense current preferentially flows through the region in which the resistance is relatively low. JP 2003-298143A discloses that the sense current has an ohmic characteristic when passing through the first layer. Therefore, the MR element disclosed in this publication is not a TMR element but a CPP-GMR element. Such a CPP-GMR element is called a current-confined-path CPP-GMR element, for example. JP 2003-298143A further discloses that the intermediate layer further includes a second layer (an interface adjusting intermediate layer) made of a nonmagnetic metal that is disposed between the first layer and the magnetization pinned layer, and between the first layer and the magnetization free layer.

JP 2003-8102A discloses a CPP-GMR element including: a magnetization pinned layer whose direction of magnetization is pinned; a magnetization free layer whose direction of magnetization changes in response to an external magnetic field; a nonmagnetic metal intermediate layer provided between the magnetization pinned layer and the magnetization free layer; and a resistance adjustment layer provided between the magnetization pinned layer and the magnetization free layer and made of a material containing conductive carriers not more than 10²² /cm³. JP 2003-8102A discloses that the material of the resistance adjustment layer is preferably a semiconductor or a semimetal.

JP 2006-86476A discloses a magnetic recording element including: a free layer whose direction of magnetization is changed by the action of spin-polarized electrons; a pinned layer whose direction of magnetization is fixed; and an intermediate layer made of a nonmagnetic material and provided between the pinned layer and the free layer. JP 2006-86476A lists a nonmagnetic metal, an insulating material and a semiconductor material as the material of the intermediate layer. In this magnetic recording element, the direction of magnetization of the free layer is changed by injecting spin-polarized electrons into the free layer.

JP 6-97531A discloses an MR element having a structure in which a semiconductor layer is sandwiched between two magnetic layers. In this MR element, a Schottky barrier formed between the semiconductor layer and the magnetic layers is utilized as a tunnel barrier.

To use a TMR element for a read head, it is required that the TMR element be reduced in resistance. The reason for this will now be described. Improvements in both recording density and data transfer rate are required of a magnetic disk drive. Accordingly, it is required that the read head exhibit a good high frequency response. However, a TMR element with a high resistance would cause a high stray capacitance in the TMR element and a circuit connected thereto, thereby degrading the high frequency response of the read head. For this reason, it is required that the TMR element be reduced in resistance.

To reduce the resistance of the TMR element, it is typically effective to reduce the thickness of the tunnel barrier layer. However, an excessive reduction in the thickness of the tunnel barrier layer made of an insulating layer would cause a number of pinholes to develop in the tunnel barrier layer, resulting in a shorter service life of the TMR element. In addition to this, a magnetic coupling may also be established between the free layer and the pinned layer, resulting in deterioration of characteristics of the TMR element such as an increase in noise and a reduction in MR ratio.

On the other hand, a CPP-GMR element has a problem that it cannot provide a sufficiently high MR ratio. This is presumably because spin-polarized electrons are scattered at the interface between the nonmagnetic conductive layer and a magnetic layer or in the nonmagnetic conductive layer.

Additionally, a CPP-GMR element is small in magnetoresistance change amount because of its low resistance. Accordingly, in order to obtain higher read output power using a CPP-GMR element, it is necessary to apply a higher voltage to the element. However, the application of a higher voltage to the element would raise the following problems. In a CPP-GMR element, a current is fed in the direction perpendicular to the plane of each layer. This would cause spin-polarized electrons to be injected from the free layer into the pinned layer or from the pinned layer into the free layer. These spin-polarized electrons would produce torque in the free layer or the pinned layer to rotate the magnetization thereof. This torque is herein referred to as spin torque. The spin torque is proportional to the current density. As the voltage applied to the CPP-GMR element is increased, the current density will also increase, thereby causing an increase in the spin torque. An increase in the spin torque would lead to a change in the direction of magnetization of the pinned layer.

The magnetic recording element disclosed in JP 2006-86476A is designed to make use of the aforementioned spin torque to change the direction of magnetization of the free layer. However, as described above, for a CPP-GMR element used for a read head, an increase in spin torque is undesirable because it would change the direction of magnetization of the pinned layer to thereby cause deterioration of the characteristics of the read head.

A current-confined-path CPP-GMR element such as the element disclosed in JP 2003-298143A allows the resistance and magnetoresistance change amount thereof to be greater as compared with a typical CPP-GMR element. In a current-confined-path CPP-GMR element, however, a layer for producing the current confining effect is formed by performing oxidation treatment in many cases, and because of this, the state of the layer for producing the current confining effect greatly varies, which can result in great variations in characteristics. In JP 2003-298143A also, the first layer (oxide intermediate layer) is formed by subjecting a metal layer to oxidation treatment.

JP 2003-298143A teaches that it is desirable that the resistance of the MR element be 1000 mΩμm² or lower because, if the resistance of the MR element far exceeds 1000 mΩμm², the element resistance is too high and problems such as heat generation thus occur when the element is processed into a head accommodating track widths of 0.1 to 0.2 μm. However, JP 2003-298143A does not specifically disclose how much heat will actually be generated or how the heat generation becomes a problem, and it is therefore unclear what is the basis for the teaching that it is desirable that the resistance be 1000 mΩμm² or lower. A read head employing a TMR element available in the current state of the art has a track width of 0.1 μm, for example, and a resistance-area product (that may be hereinafter referred to as RA) of 3 to 4 Ωμm², for example. Heat generation has not become a problem in such a read head, however.

The CPP-GMR element disclosed in JP 2003-8102A allows the resistance and magnetoresistance change amount thereof to be greater as compared with a typical CPP-GMR element. JP 2003-8102A discloses that, in order to prevent an increase in resistance of the element and relaxation of spins in the resistance adjustment layer, it is preferred that the resistance adjustment layer be smaller in thickness and that the thickness be 1 nm or smaller. However, if the resistance adjustment layer is made to have a thickness of 1 nm or smaller in the case where a semiconductor is used as the material of the resistance adjustment layer, the resistance adjustment layer cannot have satisfactory crystallinity and therefore cannot perform the function of the semiconductor.

According to the MR element disclosed in JP 6-97531A, it is possible to make the thickness of the semiconductor layer greater than that of a tunnel barrier layer of a TMR element wherein the tunnel barrier layer is made of an insulating layer. In this MR element, however, since the semiconductor layer touches the magnetic layers, the material constituting the magnetic layers may diffuse into the semiconductor layer in the process of heat treatment performed when the MR element is formed, and as a result, characteristics of the MR element such as resistance may vary.

### OBJECT AND SUMMARY OF THE INVENTION

It is an object of the present invention to provide a magnetoresistive element that utilizes a tunneling magnetoresistive effect and achieves a high MR ratio and stable characteristics, and a thin-film magnetic head, a head gimbal assembly, a head arm assembly and a magnetic disk drive each of which includes the magnetoresistive element, and to provide a magnetic memory element.

A magnetoresistive element of the invention includes: a free layer having a direction of magnetization that changes in response to an external magnetic field; a pinned layer having a fixed direction of magnetization; and a spacer layer disposed between the free layer and the pinned layer. In the magnetoresistive element, a current for detecting magnetic signals is fed in a direction intersecting the plane of each of the foregoing layers. The spacer layer includes: a semiconductor layer made of an n-type semiconductor; and a Schottky barrier forming layer that is made of a metal material having a work function higher than that of the n-type semiconductor that the semiconductor layer is made of, the Schottky barrier forming layer being disposed in at least one of a position between the semiconductor layer and the free layer and a position between the semiconductor layer and the pinned layer, touching the semiconductor layer and forming a Schottky barrier at an interface between the semiconductor layer and the Schottky barrier forming layer. The semiconductor layer has a thickness within a range of 1.1 to 1.7 nm. The Schottky barrier forming layer has a thickness within a range of 0.1 to 0.3 nm.

In the magnetoresistive element of the invention, the n-type semiconductor that the semiconductor layer is made of may be composed of a material containing ZnO, and the metal material that the Schottky barrier forming layer is made of may contain at least one of Os, Ir, Pt, Pd, Ni, Au and Co.

In the magnetoresistive element of the invention, the semiconductor layer may have a first surface and a second surface that face toward opposite directions, the Schottky barrier forming layer may be disposed in only one of the position between the semiconductor layer and the free layer and the position between the semiconductor layer and the pinned layer and may touch one of the first and second surfaces of the semiconductor layer. When the current for detecting magnetic signals is fed, electrons may travel into the semiconductor layer through the one of the first and second surfaces.

A thin-film magnetic head of the invention includes: a medium facing surface that faces toward a recording medium; the magnetoresistive element of the invention disposed near the medium facing surface to detect a signal magnetic field sent from the recording medium; and a pair of electrodes for feeding a current for detecting magnetic signals to the magnetoresistive element.

A head gimbal assembly of the invention includes: a slider including the thin-film magnetic head of the invention and disposed to face toward a recording medium; and a suspension flexibly supporting the slider.

A head arm assembly of the invention includes: a slider including the thin-film magnetic head of the invention and disposed to face toward a recording medium; a suspension flexibly supporting the slider; and an arm for making the slider travel across tracks of the recording medium, the suspension being attached to the arm.

A magnetic disk drive of the invention includes: a slider including the thin-film magnetic head of the invention and disposed to face toward a recording medium that is driven to rotate; and an alignment device supporting the slider and aligning the slider with respect to the recording medium.

A magnetic memory element of the invention includes: a free layer having a direction of magnetization that changes; a pinned layer having a fixed direction of magnetization; and a spacer layer disposed between the free layer and the pinned layer. In the magnetic memory element, a current for reading is fed in a direction intersecting the plane of each of the foregoing layers. The spacer layer includes: a semiconductor layer made of an n-type semiconductor; and a Schottky barrier forming layer that is made of a metal material having a work function higher than that of the n-type semiconductor that the semiconductor layer is made of, the Schottky barrier forming layer being disposed in at least one of a position between the semiconductor layer and the free layer and a position between the semiconductor layer and the pinned layer, touching the semiconductor layer and forming a Schottky barrier at an interface between the semiconductor layer and the Schottky barrier forming layer. The semiconductor layer has a thickness within a range of 1.1 to 1.7 nm. The Schottky barrier forming layer has a thickness within a range of 0.1 to 0.3 nm.

In the magnetic memory element of the invention, the n-type semiconductor that the semiconductor layer is made of may be composed of a material containing ZnO, and the metal material that the Schottky barrier forming layer is made of may contain at least one of Os, Ir, Pt, Pd, Ni, Au and Co.

In the magnetic memory element of the invention, the semiconductor layer may have a first surface and a second surface that face toward opposite directions, the Schottky barrier forming layer may be disposed in only one of the position between the semiconductor layer and the free layer and the position between the semiconductor layer and the pinned layer and may touch one of the first and second surfaces of the semiconductor layer. When the current for reading is fed, electrons may travel into the semiconductor layer through the one of the first and second surfaces.

In the magnetic memory element of the invention, the direction of magnetization of the free layer may be changeable by spin-injection-induced magnetization reversal. In this case, the Schottky barrier forming layer may be disposed only in the position between the semiconductor layer and the pinned layer.

According to the magnetoresistive element of the invention, the spacer layer includes the semiconductor layer made of an n-type semiconductor, and the Schottky barrier forming layer that is made of a metal material having a work function higher than that of the n-type semiconductor that the semiconductor layer is made of, the Schottky barrier forming layer being disposed in at least one of the position between the semiconductor layer and the free layer and the position between the semiconductor layer and the pinned layer, touching the semiconductor layer and forming a Schottky barrier at the interface between the semiconductor layer and the Schottky barrier forming layer. The thickness of the semiconductor layer is within a range of 1.1 to 1.7 nm. The thickness of the Schottky barrier forming layer is within a range of 0.1 to 0.3 nm. The magnetoresistive element of the invention thus makes it possible to form a stable Schottky barrier at the interface between the semiconductor layer and the Schottky barrier forming layer. As a result, according to the magnetoresistive element of the invention or the thin-film magnetic head, the head gimbal assembly, the head arm assembly or the magnetic disk drive including this magnetoresistive element, it is possible to obtain a high MR ratio and stable characteristics of the magnetoresistive element.

According to the magnetic memory element of the invention, the spacer layer includes the semiconductor layer made of an n-type semiconductor, and the Schottky barrier forming layer that is made of a metal material having a work function higher than that of the n-type semiconductor that the semiconductor layer is made of, the Schottky barrier forming layer being disposed in at least one of the position between the semiconductor layer and the free layer and the position between the semiconductor layer and the pinned layer, touching the semiconductor layer and forming a Schottky barrier at the interface between the semiconductor layer and the Schottky barrier forming layer. The thickness of the semiconductor layer is within a range of 1.1 to 1.7 nm. The thickness of the Schottky barrier forming layer is within a range of 0.1 to 0.3 nm. The magnetic memory element of the invention thus makes it possible to form a stable Schottky barrier at the interface between the semiconductor layer and the Schottky barrier forming layer. As a result, according to the magnetic memory element of the invention, it is possible to obtain a high MR ratio and stable characteristics.

Other and further objects, features and advantages of the invention will appear more fully from the following description.

### BRIEF DESCRIPTION OF THE DRAWINGS

FIG. 1 is a cross-sectional view of a read head including an MR element of a first embodiment of the invention.

FIG. 2 is a cross-sectional view illustrating a cross section of a thin-film magnetic head of the first embodiment of the invention, the cross section being orthogonal to the medium facing surface and the substrate.

FIG. 3 is a cross-sectional view illustrating a cross section of a pole portion of the thin-film magnetic head of the first embodiment of the invention, the cross section being parallel to the medium facing surface.

FIG. 4 is a perspective view illustrating a slider incorporated in a head gimbal assembly of the first embodiment of the invention.

FIG. 5 is a perspective view illustrating a head arm assembly of the first embodiment of the invention.

FIG. 6 is a view for illustrating the main part of a magnetic disk drive of the first embodiment of the invention.

FIG. 7 is a top view of the magnetic disk drive of the first embodiment of the invention.

FIG. 8 is a cross-sectional view of a read head including an MR element of a first modification example of the first embodiment of the invention.

FIG. 9 is a cross-sectional view of a read head including an MR element of a second modification example of the first embodiment of the invention.

FIG. 10 is a cross-sectional view illustrating a first example of a magnetic memory element of a second embodiment of the invention.

FIG. 11 is a cross-sectional view illustrating a second example of the magnetic memory element of the second embodiment of the invention.

FIG. 12 is a cross-sectional view illustrating a third example of the magnetic memory element of the second embodiment of the invention.

FIG. 13 is a cross-sectional view illustrating a fourth example of the magnetic memory element of the second embodiment of the invention.

FIG. 14 is a cross-sectional view illustrating a fifth example of the magnetic memory element of the second embodiment of the invention.

FIG. 15 is a cross-sectional view illustrating a sixth example of the magnetic memory element of the second embodiment of the invention.

### DETAILED DESCRIPTION OF THE PREFERRED EMBODIMENTS

### First Embodiment

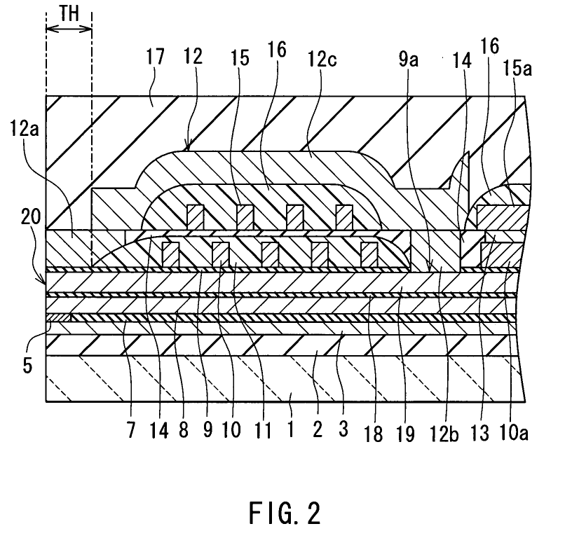

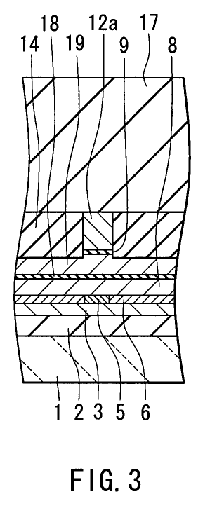

Embodiments of the present invention will now be described in detail with reference to the accompanying drawings. Reference is now made to FIG. 2 and FIG. 3 to describe the outlines of the configuration and a manufacturing method of a thin-film magnetic head of a first embodiment of the invention. FIG. 2 is a cross-sectional view illustrating a cross section of the thin-film magnetic head orthogonal to a medium facing surface and a substrate. FIG. 3 is a cross-sectional view illustrating a cross section of a pole portion of the thin-film magnetic head parallel to the medium facing surface.

The thin-film magnetic head of the first embodiment has a medium facing surface 20 that faces toward a recording medium. Furthermore, the thin-film magnetic head includes: a substrate 1 made of a ceramic material such as aluminum oxide and titanium carbide (Al₂O₃—TiC); an insulating layer 2 made of an insulating material such as alumina (Al₂O₃) and disposed on the substrate 1; a first shield layer 3 made of a magnetic material and disposed on the insulating layer 2; an MR element 5 disposed on the first shield layer 3; two bias field applying layers 6 respectively disposed to be adjacent to two sides of the MR element 5; and an insulating layer 7 disposed around the MR element 5 and the bias field applying layers 6. The MR element 5 is disposed near the medium facing surface 20. The insulating layer 7 is made of an insulating material such as alumina.

The thin-film magnetic head further includes: a second shield layer 8 made of a magnetic material and disposed on the MR element 5, the bias field applying layers 6 and the insulating layer 7; a separating layer 18 made of a nonmagnetic material such as alumina and disposed on the second shield layer 8; and a bottom pole layer 19 made of a magnetic material and disposed on the separating layer 18. The magnetic material used for the second shield layer 8 and the bottom pole layer 19 is a soft magnetic material such as NiFe, CoFe, CoFeNi or FeN. Alternatively, a second shield layer that also functions as a bottom pole layer may be provided in place of the second shield layer 8, the separating layer 18 and the bottom pole layer 19.

The thin-film magnetic head further includes a write gap layer 9 made of a nonmagnetic material such as alumina and disposed on the bottom pole layer 19. The write gap layer 9 has a contact hole 9a formed at a position away from the medium facing surface 20.

The thin-film magnetic head further includes a first layer portion 10 of a thin-film coil disposed on the write gap layer 9. The first layer portion 10 is made of a conductive material such as copper (Cu). In FIG. 2, numeral 10a indicates a connecting portion of the first layer portion 10 connected to a second layer portion 15 of the thin-film coil to be described later. The first layer portion 10 is wound around the contact hole 9a.

The thin-film magnetic head further includes: an insulating layer 11 made of an insulating material and disposed to cover the first layer portion 10 of the thin-film coil and the write gap layer 9 around the first layer portion 10; a top pole layer 12 made of a magnetic material; and a connecting layer 13 made of a conductive material and disposed on the connecting portion 10a. The connecting layer 13 may be made of a magnetic material. Each of the outer and inner edge portions of the insulating layer 11 has a shape of a rounded sloped surface.

The top pole layer 12 includes a track width defining layer 12a, a coupling portion layer 12b and a yoke portion layer 12c. The track width defining layer 12a is disposed on the write gap layer 9 and the insulating layer 11 over a region extending from a sloped portion of the insulating layer 11 closer to the medium facing surface 20 to the medium facing surface 20. The track width defining layer 12a includes: a front-end portion that is formed on the write gap layer 9 and functions as the pole portion of the top pole layer 12; and a connecting portion that is formed on the sloped portion of the insulating layer 11 closer to the medium facing surface 20 and is connected to the yoke portion layer 12c. The front-end portion has a width equal to the write track width. The connecting portion has a width greater than the width of the front-end portion.

The coupling portion layer 12b is disposed on the bottom pole layer 19 at a position where the contact hole 9a is formed. The yoke portion layer 12c couples the track width defining layer 12a and the coupling portion layer 12b to each other. One of ends of the yoke portion layer 12c that is closer to the medium facing surface 20 is located apart from the medium facing surface 20. The yoke portion layer 12c is connected to the bottom pole layer 19 through the coupling portion layer 12b.

The thin-film magnetic head further includes an insulating layer 14 made of an inorganic insulating material such as alumina and disposed around the coupling portion layer 12b and the coupling portion layer 12b. The track width defining layer 12a, the coupling portion layer 12b, the connecting layer 13 and the insulating layer 14 have flattened top surfaces.

The thin-film magnetic head further includes the second layer portion 15 of the thin-film coil disposed on the insulating layer 14. The second layer portion 15 is made of a conductive material such as copper (Cu). In FIG. 2, numeral 15a indicates a connecting portion of the second layer portion 15 that is connected to the connecting portion 10a of the first layer portion 10 of the thin-film coil through the connecting layer 13. The second layer portion 15 is wound around the coupling portion layer 12b.

The thin-film magnetic head further includes an insulating layer 16 disposed to cover the second layer portion 15 of the thin-film coil and the insulating layer 14 around the second layer portion 15. Each of the outer and inner edge portions of the insulating layer 16 has a shape of rounded sloped surface. Part of the yoke portion layer 12c is disposed on the insulating layer 16.

The thin-film magnetic head further includes an overcoat layer 17 disposed to cover the top pole layer 12. The overcoat layer 17 is made of alumina, for example.

The outline of the manufacturing method of the thin-film magnetic head of the embodiment will now be described. In the manufacturing method of the thin-film magnetic head of the embodiment, first, the insulating layer 2 is formed to have a thickness of 0.2 to 5 μm, for example, on the substrate 1 by sputtering or the like. Next, on the insulating layer 2, the first shield layer 3 is formed into a predetermined pattern by plating or the like. Next, although not shown, an insulating layer made of alumina, for example, is formed over the entire surface. Next, the insulating layer is polished by chemical mechanical polishing (hereinafter referred to as CMP), for example, until the first shield layer 3 is exposed, and the top surfaces of the first shield layer 3 and the insulating layer are thereby flattened.

Next, the MR element 5, the two bias field applying layers 6 and the insulating layer 7 are formed on the first shield layer 3. Next, the second shield layer 8 is formed on the MR element 5, the bias field applying layers 6 and the insulating layer 7. The second shield layer 8 is formed by plating or sputtering, for example. Next, the separating layer 18 is formed on the second shield layer 8 by sputtering or the like. Next, the bottom pole layer 19 is formed on the separating layer 18 by plating or sputtering, for example.

Next, the write gap layer 9 is formed to have a thickness of 50 to 300 nm, for example, on the bottom pole layer 19 by sputtering or the like. Next, in order to make a magnetic path, the contact hole 9a is formed by partially etching the write gap layer 9 at a center portion of the thin-film coil that will be formed later.

Next, the first layer portion 10 of the thin-film coil is formed to have a thickness of 2 to 3 μm, for example, on the write gap layer 9. The first layer portion 10 is wound around the contact hole 9a.

Next, the insulating layer 11 is formed into a predetermined pattern to cover the first layer portion 10 of the thin-film coil and the write gap layer 9 disposed around the first layer portion 10. The insulating layer 11 is made of an organic insulating material that exhibits fluidity when heated, such as photoresist. Next, heat treatment is given at a predetermined temperature to flatten the surface of the insulating layer 11. Through this heat treatment, each of the outer and inner edge portions of the insulating layer 11 is made to have a shape of rounded sloped surface.

Next, the track width defining layer 12a of the top pole layer 12 is formed on the write gap layer 9 and the insulating layer 11 over the region extending from the sloped portion of the insulating layer 11 closer to the medium facing surface 20 described later to the medium facing surface 20.

When the track width defining layer 12a is formed, the coupling portion layer 12b is formed on the bottom pole layer 19 at the position where the contact hole 9a is formed, and the connecting layer 13 is formed on the connecting portion 10a at the same time.

Next, pole trimming is performed. That is, in a region around the track width defining layer 12a, the write gap layer 9 and at least a portion of the pole portion of the bottom pole layer 19 close to the write gap layer 9 are etched using the track width defining layer 12a as a mask. As a result, as shown in FIG. 3, a trim structure is formed, wherein the pole portion of the top pole layer 12, the write gap layer 9 and at least a portion of the pole portion of the bottom pole layer 19 have equal widths. The trim structure makes it possible to prevent an increase in effective track width resulting from an expansion of magnetic flux near the write gap layer 9.

Next, the insulating layer 14 is formed to have a thickness of 3 to 4 μm, for example, over the entire top surface of the layered structure that has been formed through the foregoing steps. Next, the insulating layer 14 is polished by CMP, for example, to reach the surfaces of the track width defining layer 12a, the coupling portion layer 12b and the connecting layer 13, and is thereby flattened.

Next, the second layer portion 15 of the thin-film coil is formed to have a thickness of 2 to 3 μm, for example, on the insulating layer 14 that has been flattened. The second layer portion 15 is wound around the coupling portion layer 12b.

Next, the insulating layer 16 is formed into a predetermined pattern to cover the second layer portion 15 of the thin-film coil and the insulating layer 14 disposed around the second layer portion 15. The insulating layer 16 is made of an organic insulating material that exhibits fluidity when heated, such as photoresist. Next, heat treatment is given at a predetermined temperature to flatten the surface of the insulating layer 16. Through this heat treatment, each of the outer and inner edge portions of the insulating layer 16 is made to have a shape of rounded sloped surface. Next, the yoke portion layer 12c is formed on the track width defining layer 12a, the insulating layers 14 and 16, and the coupling portion layer 12b.

Next, the overcoat layer 17 is formed to cover the entire top surface of the layered structure that has been formed through the foregoing steps. Wiring, terminals and so on are then formed on the overcoat layer 17. Finally, machining of the slider including the foregoing layers is performed to form the medium facing surface 20. The thin-film magnetic head including a write head and a read head is thus completed.

The thin-film magnetic head manufactured in this manner has the medium facing surface 20 that faces toward a recording medium, the read head, and the write head. The read head is disposed near the medium facing surface 20 to detect a signal magnetic field sent from the recording medium. The configuration of the read head will be described in detail later.

The write head includes: the bottom pole layer 19 and the top pole layer 12 that are magnetically coupled to each other and include the respective pole portions that are opposed to each other and placed in regions of the pole layers on a side of the medium facing surface 20; the write gap layer 9 provided between the pole portion of the bottom pole layer 19 and the pole portion of the top pole layer 12; and the thin-film coil 10, 15 at least part of which is placed between the bottom pole layer 19 and the top pole layer 12 and insulated from the bottom pole layer 19 and the top pole layer 12. In this thin-film magnetic head, as shown in FIG. 2, the length from the medium facing surface 20 to the end of the insulating layer 11 closer to the medium facing surface 20 corresponds to throat height TH. Note that the throat height refers to a length (height) from the medium facing surface 20 to a point at which the distance between the two pole layers starts to increase. It should be noted that, while FIG. 2 and FIG. 3 show a write head for use with the longitudinal magnetic recording system, the write head of the embodiment can be one for use with the perpendicular magnetic recording system.

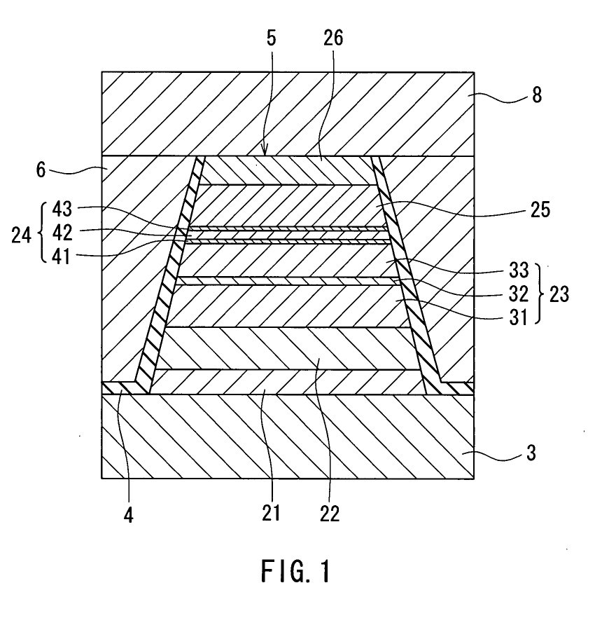

Reference is now made to FIG. 1 to describe the configuration of the read head of the embodiment in detail. FIG. 1 is a cross-sectional view illustrating a cross section of the read head parallel to the medium facing surface. As shown in FIG. 1, the read head includes the first shield layer 3 and the second shield layer 8 disposed at a specific distance from each other, and the MR element 5 disposed between the first shield layer 3 and the second shield layer 8. The MR element 5 and the second shield layer 8 are stacked on the first shield layer 3.

The read head further includes: the two bias field applying layers 6 that are respectively disposed to be adjacent to the two sides of the MR element 5 and that apply a bias magnetic field to the MR element 5; and the insulating layer 4 disposed between the first shield layer 3 and the bias field applying layers 6 and between the MR element 5 and the bias field applying layers 6.

The bias field applying layers 6 are formed using a hard magnetic layer (hard magnet) or a layered structure made up of ferromagnetic layers and antiferromagnetic layers, for example. To be specific, the bias field applying layers 6 are made of CoPt or CoCrPt, for example. The insulating layer 4 is made of alumina, for example.

The MR element 5 of the embodiment is a TMR element. In this MR element 5, a sense current, which is a current for detecting magnetic signals, is fed in a direction intersecting the plane of each layer making up the MR element 5, such as the direction perpendicular to the plane of each layer making up the MR element 5. The first shield layer 3 and the second shield layer 8 also function as a pair of electrodes for feeding the sense current to the MR element 5 in a direction intersecting the plane of each layer making up the MR element 5, such as the direction perpendicular to the plane of each layer making up the MR element 5. Alternatively, besides the first shield layer 3 and the second shield layer 8, a pair of electrodes may be provided on the top and bottom of the MR element 5, respectively. The MR element 5 has a resistance that changes in response to an external magnetic field, that is, a signal magnetic field from the recording medium. The resistance of the MR element 5 can be determined from the sense current. It is thus possible to read data stored on the recording medium through the use of the read head.

FIG. 1 shows an example of configuration of the MR element 5. This MR element 5 includes: a free layer 25 that is a ferromagnetic layer whose direction of magnetization changes in response to the signal magnetic field; a pinned layer 23 that is a ferromagnetic layer whose direction of magnetization is fixed; and a spacer layer 24 disposed between the free layer 25 and the pinned layer 23. In the example shown in FIG. 1, the pinned layer 23 is disposed closer to the first shield layer 3 than is the free layer 25. However, it is acceptable that the free layer 25 be disposed closer to the first shield layer 3 instead. The MR element 5 further includes: an antiferromagnetic layer 22 disposed on a side of the pinned layer 23 farther from the spacer layer 24; an underlying layer 21 disposed between the first shield layer 3 and the antiferromagnetic layer 22; and a protection layer 26 disposed between the free layer 25 and the second shield layer 8. In the MR element 5 shown in FIG. 1, the underlying layer 21, the antiferromagnetic layer 22, the pinned layer 23, the spacer layer 24, the free layer 25 and the protection layer 26 are stacked in this order on the first shield layer 3.

The antiferromagnetic layer 22 is a layer for fixing the direction of magnetization of the pinned layer 23 by means of exchange coupling with the pinned layer 23. The underlying layer 21 is provided for improving the crystallinity and orientability of each layer formed thereon and particularly for enhancing the exchange coupling between the antiferromagnetic layer 22 and the pinned layer 23. The protection layer 26 is a layer for protecting the layers located therebelow.

The underlying layer 21 has a thickness of 2 to 6 nm, for example. For example, a layered structure made up of a Ta layer and a Ru layer is used as the underlying layer 21.

The antiferromagnetic layer 22 has a thickness of 5 to 30 nm, for example. The antiferromagnetic layer 22 is made of an antiferromagnetic material containing Mn and at least one element M_{II} selected from the group consisting of Pt, Ru, Rh, Pd, Ni, Cu, Ir, Cr and Fe, for example. The Mn content of the material is preferably equal to or higher than 35 atomic percent and lower than or equal to 95 atomic percent, while the content of the other element M_{II} of the material is preferably equal to or higher than 5 atomic percent and lower than or equal to 65 atomic percent. There are two types of the antiferromagnetic material, one is a non-heat-induced antiferromagnetic material that exhibits antiferromagnetism without any heat treatment and induces an exchange coupling magnetic field between a ferromagnetic material and itself, and the other is a heat-induced antiferromagnetic material that exhibits antiferromagnetism by undergoing heat treatment. The antiferromagnetic layer 22 can be made of either of these types. The non-heat-induced antiferromagnetic materials include a Mn alloy that has a γ phase, such as RuRhMn, FeMn, and IrMn. The heat-induced antiferromagnetic materials include a Mn alloy that has a regular crystal structure, such as PtMn, NiMn, and PtRhMn.

As a layer for fixing the direction of magnetization of the pinned layer 23, a hard magnetic layer made of a hard magnetic material such as CoPt may be provided in place of the antiferromagnetic layer 22 described above. In this case, the material of the underlying layer 21 is Cr, CrTi or TiW, for example.

In the pinned layer 23, the direction of magnetization is fixed by exchange coupling with the antiferromagnetic layer 22 at the interface between the antiferromagnetic layer 22 and the pinned layer 23. The pinned layer 23 of the embodiment is a so-called synthetic pinned layer, having an outer layer 31, a nonmagnetic middle layer 32 and an inner layer 33 that are stacked in this order on the antiferromagnetic layer 22. Each of the outer layer 31 and the inner layer 33 includes a ferromagnetic layer made of a ferromagnetic material containing at least Co selected from the group consisting of Co and Fe, for example. The outer layer 31 and the inner layer 33 are antiferromagnetic-coupled to each other and the directions of magnetization thereof are fixed to opposite directions. The outer layer 31 has a thickness of 1.5 to 7 nm, for example. The inner layer 33 has a thickness of 1.5 to 10 nm, for example.

The nonmagnetic middle layer 32 has a thickness of 0.35 to 1.0 nm, for example. The nonmagnetic middle layer 32 is made of a nonmagnetic material containing at least one element selected from the group consisting of Ru, Rh, Ir, Re, Cr, Zr and Cu, for example. The nonmagnetic middle layer 32 is provided for producing antiferromagnetic exchange coupling between the inner layer 33 and the outer layer 31, and for fixing the magnetizations of the inner layer 33 and the outer layer 31 to opposite directions. Note that the magnetizations of the inner layer 33 and the outer layer 31 in opposite directions include not only the case in which there is a difference of 180 degrees between these directions of magnetizations, but also the case in which there is a difference of 180±120 degrees between them.

The spacer layer 24 of the embodiment includes: a semiconductor layer 42 made of an n-type semiconductor and having two surfaces that face toward opposite directions; a Schottky barrier forming layer 41 disposed between the semiconductor layer 42 and the pinned layer 23; and a Schottky barrier forming layer 43 disposed between the semiconductor layer 42 and the free layer 25. Each of the Schottky barrier forming layers 41 and 43 is made of a metal material having a work function higher than that of the n-type semiconductor that the semiconductor layer 42 is made of, touches the semiconductor layer 42 and forms a Schottky barrier at the interface between the semiconductor layer 42 and itself. The Schottky barrier forming layer 41 touches the inner layer 33, and the Schottky barrier forming layer 43 touches the free layer 25. The semiconductor layer 42 has a thickness within a range of 1.1 to 1.7 nm. Each of the Schottky barrier forming layers 41 and 43 has a thickness within a range of 0.1 to 0.3 nm.

In the embodiment, it suffices that a Schottky barrier forming layer is disposed in at least one of the position between the semiconductor layer 42 and the pinned layer 23 and the position between the semiconductor layer 42 and the free layer 25. It is therefore acceptable that one of the Schottky barrier forming layers 41 and 43 may not be provided. Examples in which one of the Schottky barrier forming layers 41 and 43 is not provided will be described later, as a first and a second modification example.

The n-type semiconductor that the semiconductor layer 42 is made of is composed of a material that contains, as a semiconductor material, one of ZnO, ZnS, SnO₂, TiO₂, and In₂O₃, for example. Of these, ZnO is particularly preferable as the semiconductor material. The n-type semiconductor that the semiconductor layer 42 is made of may be composed of a material that contains, as well as the semiconductor material, an additive that creates a donor level in the semiconductor layer 42. In the case of employing ZnO as the semiconductor material, the additive can be at least one of Ga₂O₃, In₂O₃, Al₂O₃, MgO, BO, MnO, CrO, CoO, and Fe₂O₃, for example.

As mentioned above, each of the Schottky barrier forming layers 41 and 43 is made of a metal material whose work function is higher than that of the n-type semiconductor that the semiconductor layer 42 is made of. Table 1 below lists the work functions of various materials.

TABLE 1

| Material | Work function (eV) |
|---|---|
| Os | 5.93 |
| Ir | 5.76 |
| Pt | 5.64 |
| Pd | 5.55 |
| Ni | 5.15 |
| Au | 5.1 |
| Co | 5 |
| Ru | 4.71 |
| Fe | 4.5 |
| Cu | 4.65 |
| Al | 4.28 |
| Ag | 4.26 |
| Mg | 3.66 |
| MgO | 3.55 |
| ZnO | 4.88 |

As shown in Table 1, Os, Ir, Pt, Pd, Ni, Au, and Co each have a work function of 5 eV or higher, that is, they have a work function higher than that of ZnO, 4.88 eV. Therefore, in the case where the n-type semiconductor to form the semiconductor layer 42 is to be composed of a material containing ZnO as the semiconductor material, it is preferable that the metal material to form the Schottky barrier forming layers 41 and 43 contain at least one of Os, Ir, Pt, Pd, Ni, Au and Co, which are higher in work function than ZnO. Among the above-listed materials, it is more preferable to employ one of Pt, Ni, Au and Co as the metal material to form the Schottky barrier forming layers 41 and 43, because they are such materials that the s-orbital electrons are conduction electrons and the conduction of the electrons is allowed with spin information thereof conserved.

The free layer 25 has a thickness of 2 to 10 nm, for example. The free layer 25 is formed of a ferromagnetic layer having a low coercivity. The free layer 25 may include a plurality of ferromagnetic layers stacked.

The protection layer 26 has a thickness of 0.5 to 20 nm, for example. The protection layer 26 may be a Ta layer or a Ru layer, for example. Alternatively, the protection layer 26 may have a two-layer structure made up of a combination of layers such as Ta and Ru layers, or may have a three-layer structure made up of a combination of layers such as a combination of Ta, Ru and Ta layers or a combination of Ru, Ta and Ru layers.

At least one of the inner layer 33 and the free layer 25 may include a Heusler alloy layer.

The resistance-area product (hereinafter referred to as RA) of the MR element 5 of the embodiment is preferably 0.5 Ω·μm² or above.

A manufacturing method of the read head of FIG. 1 will now be described. In the manufacturing method of this read head, first, the first shield layer 3 having a predetermined pattern is formed on the insulating layer 2 by plating or the like. Next, on the first shield layer 3, films to be the respective layers making up the MR element 5 are formed one by one by sputtering, for example, to form a layered structure consisting of these films. Next, this layered structure is patterned by etching to thereby form the MR element 5. Next, the insulating layer 4 and the bias field applying layers 6 are formed in this order by sputtering, for example. Next, the second shield layer 8 is formed by plating or sputtering, for example, on the MR element 5 and the bias field applying layers 6.

In the embodiment, in the case of forming the semiconductor layer 42 using an oxide semiconductor material, the semiconductor layer 42 is formed by sputtering with a target made of the oxide semiconductor material, not by subjecting a metal film to oxidation. For example, to form the semiconductor layer 42 made of ZnO, sputtering with a target made of sintered ZnO is employed. This produces the semiconductor layer 42 made of ZnO having a wurtzite crystal structure wherein the (002) plane is preferentially oriented.

The operation of the thin-film magnetic head of the embodiment will now be described. The thin-film magnetic head writes data on a recording medium by using the write head and reads data written on the recording medium by using the read head.

In the read head, the direction of the bias magnetic field produced by the bias field applying layers 6 intersects the direction orthogonal to the medium facing surface 20 at a right angle. In the MR element 5, when no signal magnetic field is present, the direction of magnetization of the free layer 25 is aligned with the direction of the bias magnetic field. On the other hand, the direction of magnetization of the pinned layer 23 is fixed to the direction orthogonal to the medium facing surface 20.

In the MR element 5, the direction of magnetization of the free layer 25 changes in response to the signal magnetic field sent from the recording medium. This causes a change in the relative angle between the direction of magnetization of the free layer 25 and the direction of magnetization of the pinned layer 23, and as a result, the resistance of the MR element 5 changes. The resistance of the MR element 5 can be determined from the potential difference between the first and second shield layers 3 and 8 produced when a sense current is fed to the MR element 5 from the shield layers 3 and 8. Thus, it is possible for the read head to read data stored on the recording medium.

In the MR element 5 of the embodiment, the spacer layer 24 includes the semiconductor layer 42 made of an n-type semiconductor, the Schottky barrier forming layer 41 disposed between the semiconductor layer 42 and the pinned layer 23, and the Schottky barrier forming layer 43 disposed between the semiconductor layer 42 and the free layer 25. Each of the Schottky barrier forming layers 41 and 43 is made of a metal material whose work function is higher than that of the n-type semiconductor that the semiconductor layer 42 is made of, touches the semiconductor layer 42 and forms a Schottky barrier at the interface between the semiconductor layer 42 and itself. The Schottky barrier functions as a tunnel barrier through which electrons are capable of passing with spins thereof conserved by the tunnel effect. Thus, the MR element 5 of the embodiment is an MR element utilizing the tunneling magnetoresistive effect, that is, a TMR element.

In the embodiment, the thickness of the semiconductor layer 42 is within a range of 1.1 to 1.7 nm, and the thickness of each of the Schottky barrier forming layers 41 and 43 is within a range of 0.1 to 0.3 nm. The thickness of each of the Schottky barrier forming layers 41 and 43 is determined based on the results of a first experiment that will be described later. The thickness of the semiconductor layer 42 is determined based on the results of a second experiment that will be described later. According to the embodiment, as will be described in detail later, it is possible for the MR element 5 to achieve a high MR ratio and stable characteristics.

The first experiment will now be described. In this experiment, six types of MR element samples numbered 1 to 6 were prepared, and the MR ratio (%) and the RA (Ω·μm²) of these samples (MR elements) were determined.

The film configuration of the samples 2 to 6 is the same as that of the MR element 5 of the embodiment shown in FIG. 1. The specific film configuration of the samples 2 to 6 is shown in Table 2 below. As shown in Table 2, for the samples 2 to 6, the semiconductor layer 42 is made of ZnO, and the Schottky barrier forming layers 41 and 43 are made of Pt. The thicknesses of the Schottky barrier forming layer 41, the semiconductor layer 42 and the Schottky barrier forming layer 43 in the samples used in the first and second experiments are hereinafter denoted as T1, T2, and T3, respectively. The sample 1 has a film configuration obtained by omitting the Schottky barrier forming layers 41 and 43 from the film configuration shown in Table 2. Therefore, it can also be said that the sample 1 has the film configuration of Table 2 wherein the thicknesses T1, T3 of the Schottky barrier forming layers 41, 43 are each zero.

TABLE 2

| Layer | | Material | Thickness (nm) |
|---|---|---|---|
| Protection layer | | Ta | 5 |
| | | Ru | 2 |
| Free layer | | NiFe | 4 |
| | | CoFe | 1 |
| Spacer | Schottky barrier forming layer | Pt | T3 |
| layer | Semiconductor layer | ZnO | T2 |
| | Schottky barrier forming layer | Pt | T1 |
| Pinned | Inner layer | CoFe | 2.5 |
| layer | Nonmagnetic middle layer | Ru | 0.8 |
| | Outer layer | CoFe | 3 |

| | | |
|---|---|---|
| Antiferromagnetic layer | IrMn | 5 |
| Underlying layer | Ru | 2 |
| | Ta | 1 |

In the samples 1 to 6, the thickness T2 of the semiconductor layer 42 is 1.5 nm. The thickness T1, T3 of the Schottky barrier forming layers 41, 43 is different among the samples 1 to 6. Table 3 below shows the thickness T1, T3 (μm) of the Schottky barrier forming layers 41, 43, the MR ratio (%) and the RA (Ω·μm²) for each of the samples 1 to 6.

TABLE 3

| Sample | T1, T3 (nm) | MR ratio (%) | RA (Ω · μm²) |
|---|---|---|---|
| 1 | 0 | 3.1 | 0.2 |
| 2 | 0.1 | 15.9 | 3.1 |
| 3 | 0.2 | 15.9 | 4.7 |
| 4 | 0.3 | 12.7 | 8.2 |
| 5 | 0.4 | 9.2 | 8.2 |
| 6 | 0.5 | 4.7 | 7.4 |

As can be seen from Table 3, for each of the samples 2 to 4 in which the thickness T1, T3 of the Schottky barrier forming layers 41, 43 is within a range of 0.1 to 0.3 nm, a satisfactorily high MR ratio and an RA adequate for functioning as a TMR element are attained. For the sample 1 in which the thickness T1, T3 is zero, the MR ratio and the RA are extremely low. For the samples 5 and 6 in which the thickness T1, T3 is greater than 0.3 nm, the MR ratio is lower as compared with the samples 2 to 4.

The foregoing results can be explained as follows. When the thickness T1, T3 of the Schottky barrier forming layers 41, 43 is smaller than 0.1 nm, the Schottky barrier forming layers 41 and 43 cannot take the form of a layer. Therefore, in this case, no Schottky barrier is formed at the interface between the semiconductor layer 42 and each of the Schottky barrier forming layers 41 and 43, and as a result, no tunneling magnetoresistive effect is exhibited. This leads to reductions in RA and MR ratio. On the other hand, when the thickness T1, T3 is greater than 0.3 nm, it is more likely that the scattering of spins noticeably occurs in the Schottky barrier forming layers 41 and 43, which results in a reduction in MR ratio. In view of these, it is desirable that the thickness T1, T3 of the Schottky barrier forming layers 41, 43 be within a range of 0.1 to 0.3 nm. Accordingly, in the embodiment, the thickness of each of the Schottky barrier forming layers 41 and 43 is defined to be within the range of 0.1 to 0.3 nm.

The second experiment will now be described. In this experiment, 16 types of MR element samples numbered 11 to 18 and 21 to 28 were prepared, and the MR ratio (%) and the RA (Ω·μm²) of these samples (MR elements) were determined. The specific film configuration of the samples 11 to 18 and the samples 21 to 28 is as shown in Table 2.

In the samples 11 to 18, the thickness T1, T3 of the Schottky barrier forming layers 41, 43 is 0.2 nm. The thickness T2 of the semiconductor layer 42 is different among the samples 11 to 18. Table 4 below shows the thickness T2 (μm) of the semiconductor layer 42, the MR ratio (%) and the RA (Ω·μm²) for each of the samples 11 to 18.

TABLE 4

| Sample | T2 (nm) | MR ratio (%) | RA (Ω · μm²) |
|---|---|---|---|
| 11 | 0.80 | 4.4 | 0.3 |
| 12 | 0.10 | 5.2 | 0.3 |
| 13 | 0.11 | 11.4 | 0.5 |
| 14 | 0.12 | 12.4 | 2.3 |
| 15 | 0.13 | 13.4 | 3.6 |
| 16 | 0.15 | 13.2 | 8.9 |
| 17 | 0.17 | 12.3 | 13.8 |
| 18 | 0.20 | 8.8 | 14.4 |

In the samples 21 to 28, the thickness T1, T3 of the Schottky barrier forming layers 41, 43 is 0.1 nm. The thickness T2 of the semiconductor layer 42 is different among the samples 21 to 28. Table 5 below shows the thickness T2 (μm) of the semiconductor layer 42, the MR ratio (%) and the RA (Ω·μm²) for each of the samples 21 to 28.

TABLE 5

| Sample | T2 (nm) | MR ratio (%) | RA (Ω · μm²) |
|---|---|---|---|
| 21 | 0.80 | 2.1 | 0.2 |
| 22 | 0.10 | 6.1 | 0.3 |
| 23 | 0.11 | 15.2 | 0.5 |
| 24 | 0.12 | 17.5 | 0.7 |
| 25 | 0.13 | 18.2 | 1.0 |
| 26 | 0.15 | 15.9 | 3.1 |
| 27 | 0.17 | 12.5 | 4.2 |
| 28 | 0.20 | 9.2 | 5.2 |

As can be seen from Table 4 and Table 5, for each of the samples 13 to 17 and 23 to 27 in which the thickness T2 of the semiconductor layer 42 is within a range of 1.1 and 1.7 nm, a satisfactorily high MR ratio and an RA adequate for functioning as a TMR element are attained. For the samples 11, 12, 21 and 22 in which the thickness T is 1.0 nm or smaller, the MR ratio and the RA are both lower as compared with the samples 13 to 17 and 23 to 27. For the samples 18 and 28 in which the thickness T2 is greater than 1.7 nm, the MR ratio is lower as compared with the samples 13 to 17 and 23 to 27.

The foregoing results can be explained as follows. For the semiconductor layer 42 (ZnO film in the experiments) to function as an n-type semiconductor, it is required that the semiconductor layer 42 be crystalline. However, when the thickness T2 of the semiconductor layer 42 is 1.0 nm or smaller, the crystallinity of the semiconductor layer 42 is poor and therefore the semiconductor layer 42 cannot function as an n-type semiconductor. Therefore, in this case, no Schottky barrier is formed at the interface between the semiconductor layer 42 and each of the Schottky barrier forming layers 41 and 43, and as a result, no tunneling magnetoresistive effect is exhibited. This leads to reductions in RA and MR ratio. On the other hand, when the thickness T2 is greater than 1.7 nm, scattering of spins will occur in the semiconductor layer 42, resulting in a reduction in MR ratio. In view of these, it is desirable that the thickness T2 be within a range of 1.1 to 1.7 nm. Accordingly, in the embodiment, the thickness of the semiconductor layer 42 is defined to be within the range of 1.1 to 1.7 nm.

Furthermore, it is indicated from Tables 3 to 5 that, if the requirements of the semiconductor layer 42 and the Schottky barrier forming layers 41 and 43 of the embodiment are satisfied, it is at least possible for the MR element 5 to have an RA within a range of 0.5 to 13.8 Ω·μm².

As has been described above, according to the embodiment, it is possible to form a stable Schottky barrier at the interface between the semiconductor layer 42 and each of the Schottky barrier forming layers 41 and 43. Furthermore, according to the embodiment, the Schottky barrier forming layers 41 and 43 make it possible to prevent the material that forms the pinned layer 23 and/or the material that forms the free layer 25 from diffusing into the semiconductor layer 42 to cause a change in characteristics, such as the resistance, of the MR element 5. By virtue of these features, according to the embodiment, it is possible to provide the MR element 5 capable of achieving a high MR ratio and stable characteristics by utilizing the tunneling magnetoresistive effect, and to provide the thin-film magnetic head including the MR element 5.

In JP 2003-298143A, the oxide intermediate layer is formed by subjecting a metal layer to oxidation treatment. This method cannot make it possible, even if the oxide intermediate layer is a ZnO layer, to allow the ZnO layer to have satisfactory crystallinity, that is, to allow the ZnO layer to function as an n-type semiconductor.

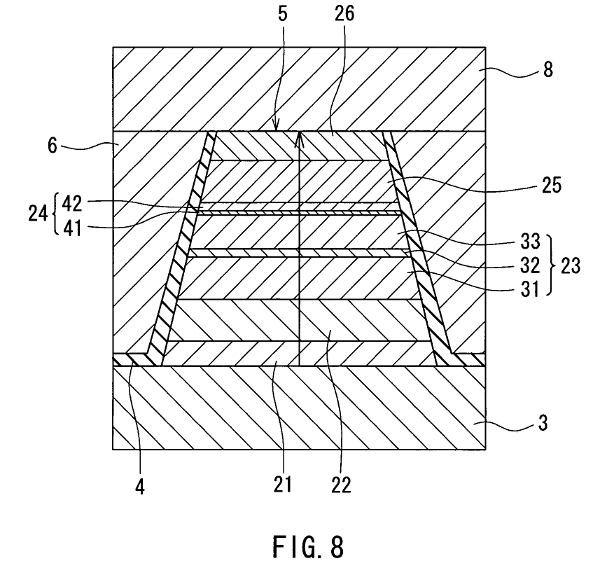

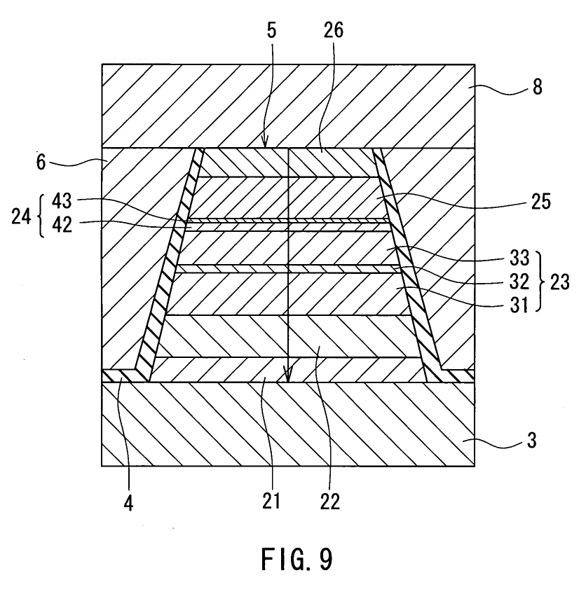

MR elements 5 of a first and a second modification example of the embodiment will now be described with reference to FIG. 8 and FIG. 9. FIG. 8 is a cross-sectional view illustrating a cross section a read head of the first modification example parallel to the medium facing surface. FIG. 9 is a cross-sectional view illustrating a cross section of a read head of the second modification example parallel to the medium facing surface.

In the MR element 5 of the first modification example shown in FIG. 8, the Schottky barrier forming layer 43 of the MR element 5 of FIG. 1 is not provided, so that the free layer 25 touches the semiconductor layer 42. The remainder of configuration of the MR element 5 of the first modification example is the same as that of the MR element 5 of FIG. 1. In the MR element 5 of the first modification example, the Schottky barrier forming layer 41 touches one of the two surfaces (the bottom surface in FIG. 8) of the semiconductor layer 42 that face toward opposite directions, so that a Schottky barrier is formed at the interface between the Schottky barrier forming layer 41 and the semiconductor layer 42. Accordingly, the MR element 5 of the first modification example also functions as a TMR element.

In the MR element 5 of the second modification example shown in FIG. 9, the Schottky barrier forming layer 41 of the MR element 5 of FIG. 1 is not provided, so that the inner layer 33 of the pinned layer 23 touches the semiconductor layer 42. The remainder of configuration of the MR element 5 of the second modification example is the same as that of the MR element 5 of FIG. 1. In the MR element 5 of the second modification example, the Schottky barrier forming layer 43 touches one of the two surfaces (the top surface in FIG. 8) of the semiconductor layer 42 that face toward opposite directions, so that a Schottky barrier is formed at the interface between the Schottky barrier forming layer 43 and the semiconductor layer 42. Accordingly, the MR element 5 of the second modification example also functions as a TMR element.

In the case where the Schottky barrier forming layer is formed in only one of the position between the semiconductor layer 42 and the free layer 25 and the position between the semiconductor layer 42 and the pinned layer 23 as in the first and the second modification example, it is desirable that the sense current be fed such that electrons travel into the semiconductor layer 42 through one of the two surfaces of the semiconductor layer 42 that the Schottky barrier forming layer 41 or 43 touches. The reason is as follows. The minimum energy required when electrons travel into the semiconductor layer 42 from the Schottky barrier forming layer 41 or 43, that is, the barrier height, is higher than the minimum energy required when electrons travel into the Schottky barrier forming layer 41 or 43 from the semiconductor layer 42, that is, the diffusion potential. Therefore, in the case where electrons travel into the semiconductor layer 42 from the Schottky barrier forming layer 41 or 43 through one of the two surfaces of the semiconductor layer 42 that the Schottky barrier forming layer 41 or 43 touches, the tunneling magnetoresistive effect is exhibited more remarkably as compared with the case where electrons travel into the Schottky barrier forming layer 41 or 43 from the semiconductor layer 42. In each of FIG. 8 and FIG. 9, the desirable direction of travel of electrons when the sense current is fed is indicated with an arrow.

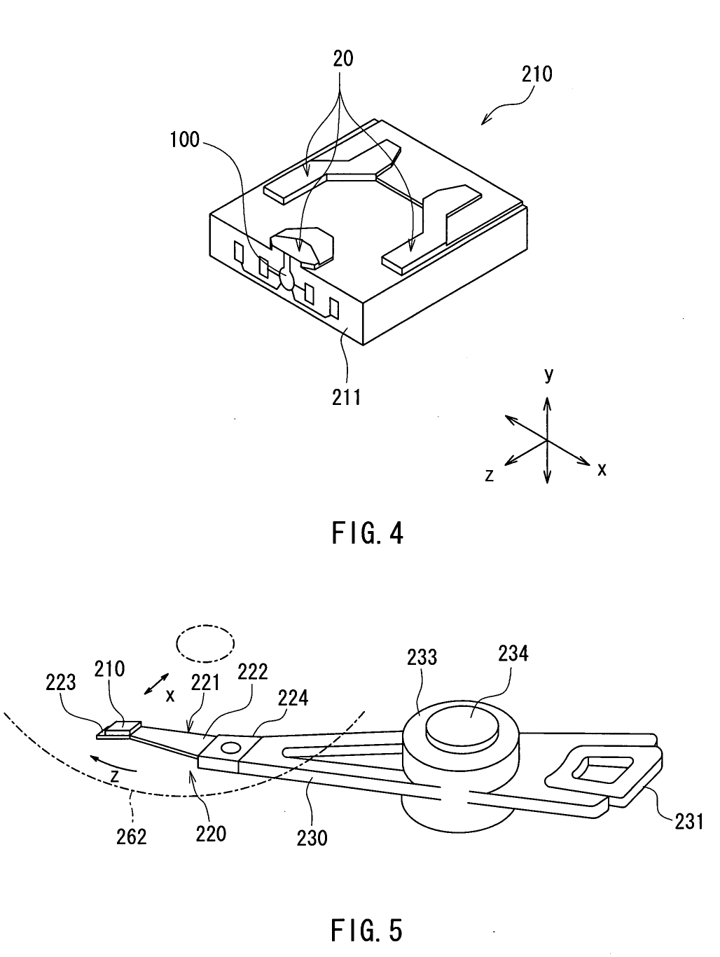

A head gimbal assembly, a head arm assembly and a magnetic disk drive of the embodiment will now be described. Reference is now made to FIG. 4 to describe a slider 210 incorporated in the head gimbal assembly. In the magnetic disk drive, the slider 210 is placed to face toward a magnetic disk platter that is a circular-plate-shaped recording medium to be driven to rotate. The slider 210 has a base body 211 made up mainly of the substrate 1 and the overcoat layer 17 of FIG. 2. The base body 211 is nearly hexahedron-shaped. One of the six surfaces of the base body 211 faces toward the magnetic disk platter. The medium facing surface 20 is formed in this one of the surfaces. When the magnetic disk platter rotates in the z direction of FIG. 4, an airflow passes between the magnetic disk platter and the slider 210, and a lift is thereby generated below the slider 210 in the y direction of FIG. 4 and exerted on the slider 210. The slider 210 flies over the surface of the magnetic disk platter by means of the lift. The x direction of FIG. 4 is across the tracks of the magnetic disk platter. The thin-film magnetic head 100 of the embodiment is formed near the air-outflow-side end (the end located at the lower left of FIG. 4) of the slider 210.

Reference is now made to FIG. 5 to describe the head gimbal assembly 220 of the embodiment. The head gimbal assembly 220 includes the slider 210 and a suspension 221 that flexibly supports the slider 210. The suspension 221 includes: a plate-spring-shaped load beam 222 made of stainless steel, for example; a flexure 223 to which the slider 210 is joined, the flexure 223 being located at an end of the load beam 222 and giving an appropriate degree of freedom to the slider 210; and a base plate 224 located at the other end of the load beam 222. The base plate 224 is attached to an arm 230 of an actuator for moving the slider 210 along the x direction across the tracks of the magnetic disk platter 262. The actuator incorporates the arm 230 and a voice coil motor that drives the arm 230. A gimbal section for maintaining the orientation of the slider 210 is provided in the portion of the flexure 223 on which the slider 210 is mounted.

The head gimbal assembly 220 is attached to the arm 230 of the actuator. An assembly having the arm 230 and the head gimbal assembly 220 attached to the arm 230 is called a head arm assembly. An assembly having a carriage with a plurality of arms wherein the head gimbal assembly 220 is attached to each of the arms is called a head stack assembly.

FIG. 5 illustrates the head arm assembly of the embodiment. In the head arm assembly, the head gimbal assembly 220 is attached to an end of the arm 230. A coil 231 that is part of the voice coil motor is fixed to the other end of the arm 230. A bearing 233 is provided in the middle of the arm 230. The bearing 233 is attached to a shaft 234 that rotatably supports the arm 230.

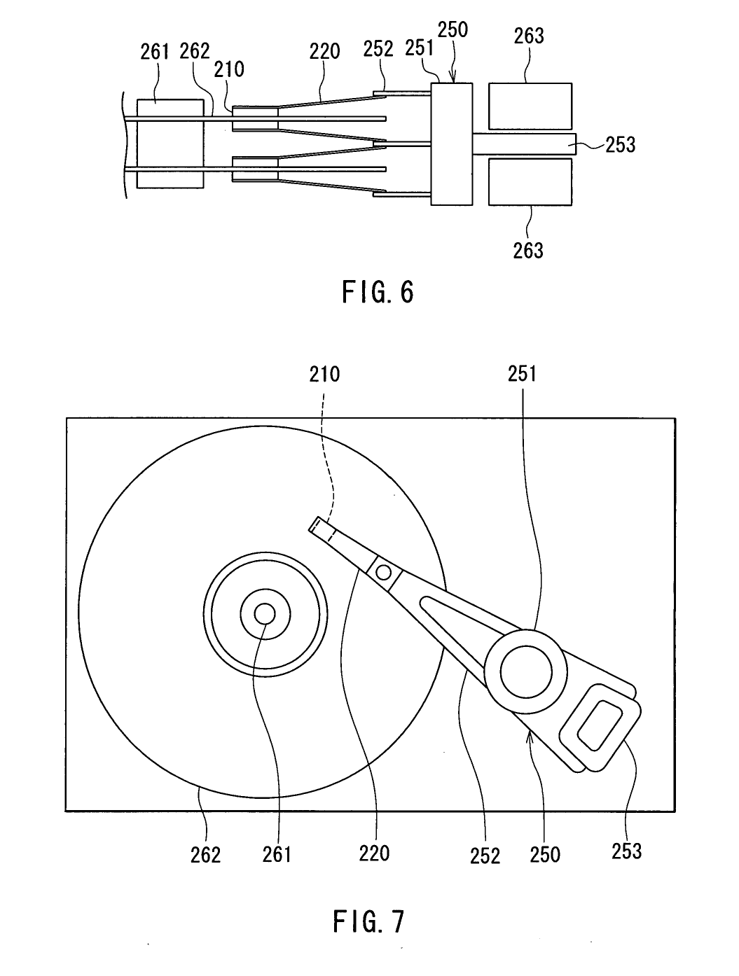

Reference is now made to FIG. 6 and FIG. 7 to describe an example of the head stack assembly and the magnetic disk drive of the embodiment. FIG. 6 illustrates the main part of the magnetic disk drive. FIG. 7 is a top view of the magnetic disk drive. The head stack assembly 250 incorporates a carriage 251 having a plurality of arms 252. A plurality of head gimbal assemblies 220 are attached to the arms 252 such that the assemblies 220 are aligned in the vertical direction with spacing between adjacent ones. A coil 253 that is part of the voice coil motor is mounted on the carriage 251 on a side opposite to the arms 252. The head stack assembly 250 is installed in the magnetic disk drive. The magnetic disk drive includes a plurality of magnetic disk platters 262 mounted on a spindle motor 261. Two of the sliders 210 are allocated to each of the platters 262, such that the two sliders 210 are opposed to each other with each of the platters 262 disposed in between. The voice coil motor includes permanent magnets 263 disposed to be opposed to each other, the coil 253 of the head stack assembly 250 being placed between the magnets 263.

The actuator and the head stack assembly 250 except the sliders 210 correspond to the alignment device of the invention and support the sliders 210 and align them with respect to the magnetic disk platters 262.

In the magnetic disk drive of the embodiment, the actuator moves the slider 210 across the tracks of the magnetic disk platter 262 and aligns the slider 210 with respect to the magnetic disk platter 262. The thin-film magnetic head incorporated in the slider 210 writes data on the magnetic disk platter 262 through the use of the write head and reads data stored on the magnetic disk platter 262 through the use of the read head.

The head gimbal assembly, the head arm assembly and the magnetic disk drive of the embodiment exhibit effects similar to those of the foregoing thin-film magnetic head of the embodiment.

### Second Embodiment

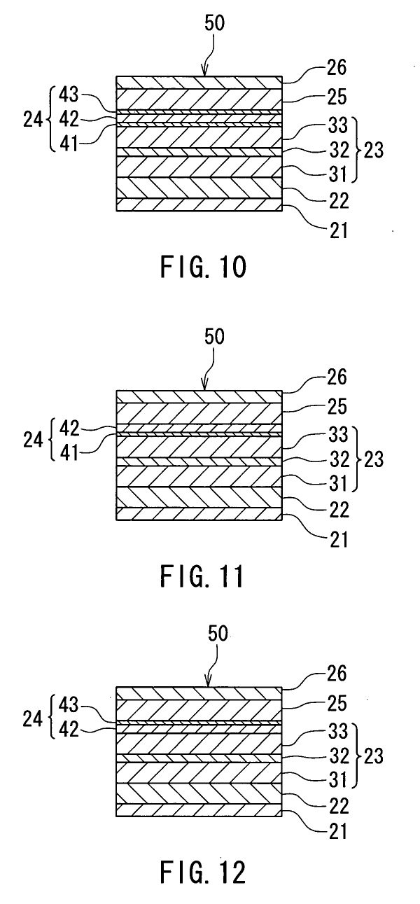

A magnetic memory element of a second embodiment of the invention will now be described with reference to FIG. 10 to FIG. 15. FIG. 10 to FIG. 15 are cross-sectional views respectively illustrating first to sixth examples of the magnetic memory element of the embodiment.

As shown in FIG. 10 to FIG. 15, the magnetic memory element 50 of the second embodiment has a basic configuration the same as that of the MR element 5 of the first embodiment. Specifically, the magnetic memory element 50 includes: a free layer 25 that is a ferromagnetic layer whose direction of magnetization changes; a pinned layer 23 that is a ferromagnetic layer whose direction of magnetization is fixed; and a spacer layer 24 disposed between the free layer 25 and the pinned layer 23. The magnetic memory element 50 further includes: an antiferromagnetic layer 22 disposed on a side of the pinned layer 23 farther from the spacer layer 24; an underlying layer 21 disposed on a side of the antiferromagnetic layer 22 farther from the pinned layer 23; and a protection layer 26 disposed on a side of the free layer 25 farther from the spacer layer 24. In the magnetic memory element 50 shown in each of FIG. 10 to FIG. 15, the antiferromagnetic layer 22, the pinned layer 23, the spacer layer 24, the free layer 25 and the protection layer 26 are stacked in this order on the underlying layer 21. The antiferromagnetic layer 22, the pinned layer 23, the spacer layer 24 and the free layer 25 may be stacked in the order reverse to the above-listed order, however. The functions and configurations of the layers constituting the magnetic memory element 50 are the same as those for the case of the MR element 5 of the first embodiment. As is the MR element 5 of the first embodiment, the magnetic memory element 50 is an MR element utilizing the tunneling magnetoresistive effect, that is, a TMR element.

In each of the first to sixth examples shown in FIG. 10 to FIG. 15, the pinned layer 23 is a so-called synthetic pinned layer, having an outer layer 31, a nonmagnetic middle layer 32 and an inner layer 33 that are stacked in this order on the antiferromagnetic layer 22.

In the magnetic memory element 50 of the first example shown in FIG. 10, the spacer layer 24 includes: a semiconductor layer 42 made of an n-type semiconductor and having two surfaces that face toward opposite directions; a Schottky barrier forming layer 41 disposed between the semiconductor layer 42 and the pinned layer 23; and a Schottky barrier forming layer 43 disposed between the semiconductor layer 42 and the free layer 25. The functions and configuration of these layers are the same as those for the case of the MR element 5 of the first embodiment. A specific example of the film configuration of the magnetic memory element 50 of the first example can be the same as the film configuration shown in Table 2, except that the free layer 25 is a single CoFe layer. In this specific example, however, the thicknesses of the respective layers are not limited to those shown in Table 2.

In the magnetic memory element 50 of the second example shown in FIG. 11, the Schottky barrier forming layer 43 of the first example of FIG. 10 is not provided, so that the free layer 25 touches the semiconductor layer 42. The remainder of configuration of the magnetic memory element 50 of the second example is the same as that of the magnetic memory element 50 of the first example of FIG. 10. The configuration of the magnetic memory element 50 of the second example corresponds to the configuration of the MR element 5 of the first modification example of the first embodiment.

In the magnetic memory element 50 of the third example shown in FIG. 12, the Schottky barrier forming layer 41 of the first example of FIG. 10 is not provided, so that the pinned layer 23 touches the semiconductor layer 42. The remainder of configuration of the magnetic memory element 50 of the third example is the same as that of the magnetic memory element 50 of the first example of FIG. 10. The configuration of the magnetic memory element 50 of the third example corresponds to the configuration of the MR element 5 of the second modification example of the first embodiment.

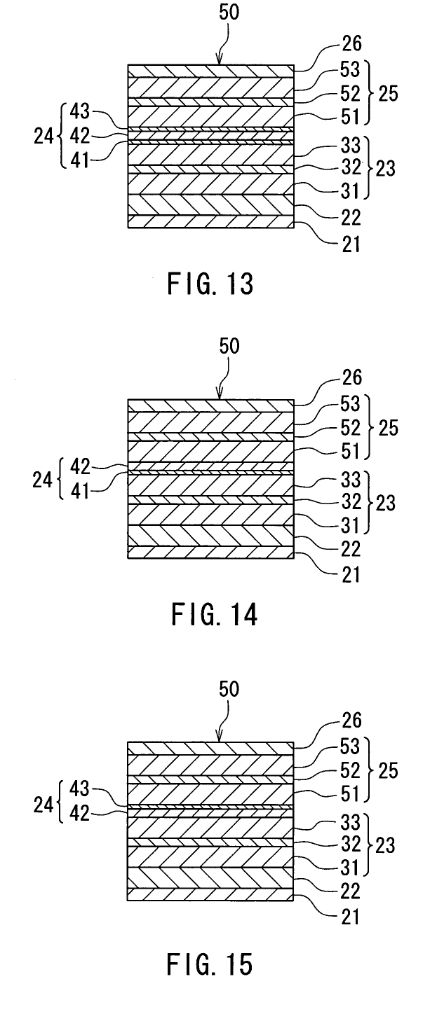

In the magnetic memory element 50 of the fourth example shown in FIG. 13, the free layer 25 includes a ferromagnetic layer 51, a nonmagnetic layer 52 and a ferromagnetic layer 53 that are stacked in this order on the spacer layer 24. Each of the ferromagnetic layers 51 and 53 is a CoFe layer, for example, and the nonmagnetic layer 52 is a Ru layer, for example. The remainder of configuration of the magnetic memory element 50 of the fourth example is the same as that of the magnetic memory element 50 of the first example of FIG. 10.

In the magnetic memory element 50 of the fifth example shown in FIG. 14, the Schottky barrier forming layer 43 of the fourth example of FIG. 13 is not provided, so that the free layer 25 touches the semiconductor layer 42. The remainder of configuration of the magnetic memory element 50 of the fifth example is the same as that of the magnetic memory element 50 of the fourth example of FIG. 13.

In the magnetic memory element 50 of the sixth example shown in FIG. 15, the Schottky barrier forming layer 41 of the fourth example of FIG. 13 is not provided, so that the pinned layer 23 touches the semiconductor layer 42. The remainder of configuration of the magnetic memory element 50 of the sixth example is the same as that of the magnetic memory element 50 of the fourth example of FIG. 13.

The operation of the magnetic memory element 50 of the embodiment will now be described. The magnetic memory element 50 stores data by rendering the direction of magnetization of the free layer 25 parallel or antiparallel to the direction of magnetization of the pinned layer 23. The direction of magnetization of the free layer 25 can be changed by an external magnetic field or by spin-injection-induced magnetization reversal. The external magnetic field is produced by, for example, passing a current through a bit line and a word line disposed to intersect near the magnetic memory element 50, and then combining a magnetic field produced by the current flowing through the bit line and a magnetic field produced by the current flowing through the word line. A detailed description will be made later regarding the method of changing the direction of magnetization of the free layer 25 by spin-injection-induced magnetization reversal.

To read data from the magnetic memory element 50, a current for reading is fed to the magnetic memory element 50 in a direction intersecting the plane of each layer making up the magnetic memory element 50, such as the direction perpendicular to the plane of each layer making up the magnetic memory element 50. The current for reading is set to such magnitude that the direction of magnetization of the free layer 25 will not be changed by the current for reading. When the current for reading is fed to the magnetic memory element 50, the resistance of the magnetic memory element 50 varies depending on whether the direction of magnetization of the free layer 25 is parallel or antiparallel to the direction of magnetization of the pinned layer 23, due to the magnetoresistive effect. It is thus possible to read data stored on the magnetic memory element 50.

In the case where the Schottky barrier forming layer is disposed in only one of the position between the semiconductor layer 42 and the free layer 25 and the position between the semiconductor layer 42 and the pinned layer 23 as in the second, third, fifth and sixth examples, it is desirable that the current for reading be fed such that electrons travel into the semiconductor layer 42 through one of the two surfaces of the semiconductor layer 42 that the Schottky barrier forming layer 41 or 43 touches. The reason is that, as described in the first embodiment, in the case where electrons travel into the semiconductor layer 42 from the Schottky barrier forming layer 41 or 43 through one of the two surfaces of the semiconductor layer 42 that the Schottky barrier forming layer 41 or 43 touches, the tunneling magnetoresistive effect is exhibited more remarkably as compared with the case where electrons travel into the Schottky barrier forming layer 41 or 43 from the semiconductor layer 42.

The method of changing the direction of magnetization of the free layer 25 by spin-injection-induced magnetization reversal will now be described. In this method, to render the direction of magnetization of the free layer 25 parallel to the direction of magnetization of the pinned layer 23, electrons are injected into the free layer 25 from the pinned layer 23 through the spacer layer 24. As a result, spin-polarized electrons are injected into the free layer 25, and the spin torque generated by the spin-polarized electrons changes the direction of magnetization of the free layer 25 so that it becomes parallel to the direction of magnetization of the pinned layer 23. To render the direction of magnetization of the free layer 25 antiparallel to that of the pinned layer 23, electrons are injected into the pinned layer 23 from the free layer 25 through the spacer layer 24. As a result, spin-polarized electrons reflected at the interface between the spacer layer 24 and the pinned layer 23 are injected into the free layer 25, and the spin torque generated by the spin-polarized electrons changes the direction of magnetization of the free layer 25 so that it becomes antiparallel to the direction of magnetization of the pinned layer 23.

To change the direction of magnetization of the free layer 25 by spin-injection-induced magnetization reversal, it is necessary that the spins of the free layer 25 undergo high spin torque. To achieve this, in the fourth to sixth examples shown in FIG. 13 to FIG. 15, the nonmagnetic layer 52 sandwiched between the ferromagnetic layers 51 and 53 is provided in the free layer 25. The nonmagnetic layer 52 is made of a material capable of increasing spin accumulation at the interface between the nonmagnetic layer 52 and the ferromagnetic layers 51 and 53, such as Ru. Providing the nonmagnetic layer 52 having such a feature makes it possible to perform spin-injection-induced magnetization reversal even at low current densities.

In the case of changing the direction of magnetization of the free layer 25 by spin-injection-induced magnetization reversal, the magnitude of current required for rendering the direction of magnetization of free layer 25 antiparallel to that of the pinned layer 23 is greater than the magnitude of current required for rendering the direction of magnetization of the free layer 25 parallel to that of the pinned layer 23. For this reason, in the case where the Schottky barrier forming layer is to be disposed in only one of the position between the semiconductor layer 42 and the free layer 25 and the position between the semiconductor layer 42 and the pinned layer 23 to form the magnetic memory element 50 to undergo spin-injection-induced magnetization reversal, it is preferable to provide the Schottky barrier forming layer between the semiconductor layer 42 and the pinned layer 23 so as to allow the current that flows when the direction of magnetization of the free layer 25 is rendered antiparallel to that of the pinned layer 23 to be greater in magnitude than the current that flows when the direction of magnetization of the free layer 25 is rendered parallel to that of the pinned layer 23. In other words, providing the Schottky barrier forming layer only between the semiconductor layer 42 and the pinned layer 23 allows the resistance of the magnetic memory element 50 to be lower in the case where the direction of magnetization of the free layer 25 is rendered antiparallel to that of the pinned layer 23 by injecting electrons from the free layer 25 to the pinned layer 23 through the spacer layer 24, compared with the case where the direction of magnetization of the free layer 25 is rendered parallel to that of the pinned layer 23 by injecting electrons from the pinned layer 23 to the free layer 25 through the spacer layer 24. This makes it easy to allow the magnitude of current to be greater when the direction of magnetization of the free layer 25 is rendered antiparallel to that of the pinned layer 23 than when the direction of magnetization of the free layer 25 is rendered parallel to that of the pinned layer 23. Therefore, as possible configurations of the magnetic memory element 50 to undergo spin-injection-induced magnetization reversal, the second example of FIG. 11 is preferable to the third example of FIG. 12, and the fifth example of FIG. 14 is preferable to the sixth example of FIG. 15.

The remainder of operation and effects of the magnetic memory element 50 of the second embodiment are similar to those of the MR element 5 of the first embodiment.

The present invention is not limited to the foregoing embodiments but various modifications can be made thereto. For example, the pinned layer 23 is not limited to a synthetic pinned layer. In addition, in the first embodiment, while descriptions have been made on the thin-film magnetic head having such a configuration that the read head is formed on the base body and the write head is stacked on the read head, the read and write heads may be stacked in the reverse order. Furthermore, when the magnetic head is to be used only for read operations, the head may be configured to include only the read head.

It is apparent that various aspects and modifications of the present invention can be implemented in the light of the foregoing descriptions. Accordingly, within the scope equivalent to that of the claims set forth below, the present invention can be carried out in embodiments other than the foregoing most preferred embodiments.

What is claimed is:

1. A magnetoresistive element comprising:
a free layer having a direction of magnetization that changes in response to an external magnetic field;
a pinned layer having a fixed direction of magnetization; and
a spacer layer disposed between the free layer and the pinned layer, wherein a current for detecting magnetic signals is fed in a direction intersecting a plane of each of the foregoing layers, and wherein:
the spacer layer includes: a semiconductor layer made of an n-type semiconductor; and a Schottky barrier forming layer that is made of a metal material having a work function higher than that of the n-type semiconductor that the semiconductor layer is made of, the Schottky barrier forming layer being disposed in at least one of a position between the semiconductor layer and the free layer and a position between the semiconductor layer and the pinned layer, touching the semiconductor layer and forming a Schottky barrier at an interface between the semiconductor layer and the Schottky barrier forming layer;
the semiconductor layer has a thickness within a range of 1.1 to 1.7 nm; and
the Schottky barrier forming layer has a thickness within a range of 0.1 to 0.3 nm.

2. The magnetoresistive element according to claim 1, wherein the n-type semiconductor that the semiconductor layer is made of is composed of a material containing ZnO, and the metal material that the Schottky barrier forming layer is made of contains at least one of Os, Ir, Pt, Pd, Ni, Au and Co.

3. The magnetoresistive element according to claim 1, wherein he semiconductor layer has two surfaces that face toward opposite directions, the Schottky barrier forming layer is disposed in only one of the position between the semiconductor layer and the free layer and the position between the semiconductor layer and the pinned layer and touches one of the two surfaces of the semiconductor layer, and, when the current for detecting magnetic signals is fed, electrons travel into the semiconductor layer through the one of the two surfaces.

4. A thin-film magnetic head comprising: a medium facing surface that faces toward a recording medium; a magnetoresistive element disposed near the medium facing surface to detect a signal magnetic field sent from the recording medium; and a pair of electrodes for feeding a current for detecting magnetic signals to the magetoresistive element,
the magetoresistive element comprising:
a free layer having a direction of magnetization that changes in response to an external magnetic field;
a pinned layer having a fixed direction of magnetization; and
a spacer layer disposed between the free layer and the pinned layer,
wherein:
in the magetoresistive element, the current for detecting magnetic signals is fed in a direction intersecting a plane of each of the foregoing layers;
the spacer layer includes: a semiconductor layer made of an n-type semiconductor; and a Schottky barrier forming layer that is made of a metal material having a work function higher than that of the n-type semiconductor that the semiconductor layer is made of, the Schottky barrier forming layer being disposed in at least one of a position between the semiconductor layer and the free layer and a position between the semiconductor layer and the pinned layer, touching the semiconductor layer and forming a Schottky barrier at an interface between the semiconductor layer and the Schottky barrier forming layer;
the semiconductor layer has a thickness within a range of 1.1 to 1.7 nm; and
the Schottky barrier forming layer has a thickness within a range of 0.1 to 0.3 nm.

5. A head gimbal assembly comprising: a slider including a thin-film magnetic head and disposed to face toward a recording medium; and a suspension flexibly supporting the slider,
the thin-film magnetic head comprising: a medium facing surface that faces toward the recording medium; a magnetoresistive element disposed near the medium facing surface to detect a signal magnetic field sent from the recording medium; and a pair of electrodes for feeding a current for detecting magnetic signals to the magetoresistive element,
the magetoresistive element comprising:
a free layer having a direction of magnetization that changes in response to an external magnetic field;
a pinned layer having a fixed direction of magnetization; and
a spacer layer disposed between the free layer and the pinned layer,
wherein:
in the magetoresistive element, the current for detecting magnetic signals is fed in a direction intersecting a plane of each of the foregoing layers;
the spacer layer includes: a semiconductor layer made of an n-type semiconductor; and a Schottky barrier forming layer that is made of a metal material having a work function higher than that of the n-type semiconductor that the semiconductor layer is made of, the Schottky barrier forming layer being disposed in at least one of a position between the semiconductor layer and the free layer and a position between the semiconductor layer and the pinned layer, touching the semiconductor layer and forming a Schottky barrier at an interface between the semiconductor layer and the Schottky barrier forming layer;
the semiconductor layer has a thickness within a range of 1.1 to 1.7 nm; and
the Schottky barrier forming layer has a thickness within a range of 0.1 to 0.3 nm.

6. A head arm assembly comprising: a slider including a thin-film magnetic head and disposed to face toward a recording medium; a suspension flexibly supporting the slider; and an arm for making the slider travel across tracks of the recording medium, the suspension being attached to the arm,
the thin-film magnetic head comprising: a medium facing surface that faces toward the recording medium; a magnetoresistive element disposed near the medium facing surface to detect a signal magnetic field sent from the recording medium; and a pair of electrodes for feeding a current for detecting magnetic signals to the magetoresistive element,
the magetoresistive element comprising:
a free layer having a direction of magnetization that changes in response to an external magnetic field;
a pinned layer having a fixed direction of magnetization; and
a spacer layer disposed between the free layer and the pinned layer,
wherein:
in the magetoresistive element, the current for detecting magnetic signals is fed in a direction intersecting a plane of each of the foregoing layers;
the spacer layer includes: a semiconductor layer made of an n-type semiconductor; and a Schottky barrier forming layer that is made of a metal material having a work function higher than that of the n-type semiconductor that the semiconductor layer is made of, the Schottky barrier forming layer being disposed in at least one of a position between the semiconductor layer and the free layer and a position between the semiconductor layer and the pinned layer, touching the semiconductor layer and forming a Schottky barrier at an interface between the semiconductor layer and the Schottky barrier forming layer;
the semiconductor layer has a thickness within a range of 1.1 to 1.7 nm; and
the Schottky barrier forming layer has a thickness within a range of 0.1 to 0.3 nm.

7. A magnetic disk drive comprising: a slider including a thin-film magnetic head and disposed to face toward a recording medium that is driven to rotate; and an alignment device supporting the slider and aligning the slider with respect to the recording medium,
the thin-film magnetic head comprising: a medium facing surface that faces toward the recording medium; a magnetoresistive element disposed near the medium facing surface to detect a signal magnetic field sent from the recording medium; and a pair of electrodes for feeding a current for detecting magnetic signals to the magetoresistive element,
the magetoresistive element comprising:
a free layer having a direction of magnetization that changes in response to an external magnetic field;
a pinned layer having a fixed direction of magnetization; and
a spacer layer disposed between the free layer and the pinned layer,
wherein:
in the magetoresistive element, the current for detecting magnetic signals is fed in a direction intersecting a plane of each of the foregoing layers;
the spacer layer includes: a semiconductor layer made of an n-type semiconductor; and a Schottky barrier forming layer that is made of a metal material having a work function higher than that of the n-type semiconductor that the semiconductor layer is made of, the Schottky barrier forming layer being disposed in at least one of a position between the semiconductor layer and the free layer and a position between the semiconductor layer and the pinned layer, touching the semiconductor layer and forming a Schottky barrier at an interface between the semiconductor layer and the Schottky barrier forming layer;
the semiconductor layer has a thickness within a range of 1.1 to 1.7 nm; and
the Schottky barrier forming layer has a thickness within a range of 0.1 to 0.3 nm.

8. A magnetic memory element comprising:
a free layer having a direction of magnetization that changes;
a pinned layer having a fixed direction of magnetization; and
a spacer layer disposed between the free layer and the pinned layer,
wherein a current for reading is fed in a direction intersecting a plane of each of the foregoing layers, and wherein:
the spacer layer includes: a semiconductor layer made of an n-type semiconductor; and a Schottky barrier forming layer that is made of a metal material having a work function higher than that of the n-type semiconductor that the semiconductor layer is made of, the Schottky barrier forming layer being disposed in at least one of a position between the semiconductor layer and the free layer and a position between the semiconductor layer and the pinned layer, touching the semiconductor layer and forming a Schottky barrier at an interface between the semiconductor layer and the Schottky barrier forming layer;
the semiconductor layer has a thickness within a range of 1.1 to 1.7 nm; and
the Schottky barrier forming layer has a thickness within a range of 0.1 to 0.3 nm.

9. The magnetic memory element according to claim 8, wherein the n-type semiconductor that the semiconductor layer is made of is composed of a material containing ZnO, and the metal material that the Schottky barrier forming layer is made of contains at least one of Os, Ir, Pt, Pd, Ni, Au and Co.

10. The magnetic memory element according to claim 8, wherein the semiconductor layer has two surfaces that face toward opposite directions, the Schottky barrier forming layer is disposed in only one of the position between the semiconductor layer and the free layer and the position between the semiconductor layer and the pinned layer and touches one of the two surfaces of the semiconductor layer, and, when the current for reading is fed, electrons travel into the semiconductor layer through the one of the two surfaces.

11. The magnetic memory element according to claim 8, wherein the direction of magnetization of the free layer is changeable by spin-injection-induced magnetization reversal.

12. The magnetic memory element according to claim 11, wherein the Schottky barrier forming layer is disposed only in the position between the semiconductor layer and the pinned layer.
